(19) United States
(12) Patent Application Publication
(10) Pub. No.: US 2026/0169897 A1
(43) Pub. Date: Jun. 18, 2026

(54) DIGITAL TWIN TELEMETRY COMPRESSION SYSTEM FOR ON-DEVICE HARDWARE AND FIRMWARE CO-MONITORING

(71) Applicant: Srikant Sudha PANDA, Lake Stevens, WA (US)

(72) Inventor: Srikant Sudha PANDA, Lake Stevens, WA (US)

(21) Appl. No.: 19/534,484

(22) Filed: Feb. 9, 2026

(51) Int. Cl. G06F 11/3668

(52) U.S. Cl. CPC G06F 11/3672

(57) ABSTRACT

The present invention relates to a digital twin telemetry compression system implemented directly on a monitored device for efficient co-monitoring of hardware and firmware states. The system performs continuous acquisition of multi-dimensional telemetry data generated by physical hardware components and firmware execution processes and applies adaptive, context-aware compression prior to external transmission. The invention employs temporal alignment of hardware and firmware telemetry, cross-layer correlation analysis, and dynamic adjustment of data precision, aggregation granularity, and temporal resolution to reduce telemetry data volume while preserving reconstructable digital twin state fidelity. Integrated validation mechanisms ensure integrity and reconstructability of compressed telemetry representations, and transmission management adapts telemetry delivery based on bandwidth availability, power state, and monitoring priority.

### TECHNICAL FIELD OF THE INVENTION

The present invention relates to the field of digital twin-based device monitoring systems and, more particularly, to an on-device telemetry compression apparatus and structural machine configuration for real-time co-monitoring of hardware and firmware states. The invention specifically concerns a digital twin telemetry compression device that performs adaptive, intelligent, and energy-efficient reduction of telemetry data generated by physical computing structures, embedded systems, industrial machines, and connected devices, while preserving semantic fidelity and monitoring accuracy across constrained bandwidth environments. The disclosed invention further relates to structural arrangements that enable compression-aware telemetry acquisition, validation, and transmission directly within the monitored device architecture.

### BACKGROUND OF THE INVENTION

Modern digital twin systems increasingly rely on continuous telemetry streams originating from physical hardware components and firmware execution layers to maintain synchronized virtual representations of operational devices. However, existing telemetry transmission architectures generate excessive data volumes due to high-frequency sensor sampling, firmware state logging, and event-driven hardware signals, resulting in substantial bandwidth consumption, transmission latency, and power inefficiency. Conventional compression approaches operate as static or externally applied post-processing techniques that lack contextual awareness of device state, firmware execution behavior, or real-time operational constraints.

Furthermore, present systems inadequately integrate compression logic within the physical device structure, leading to delayed anomaly detection, reduced observability during constrained communication windows, and inefficient digital twin synchronization. Existing solutions also fail to co-monitor hardware and firmware telemetry as a unified entity, thereby losing cross-layer correlation essential for accurate device health assessment. These deficiencies create a critical need for a device-integrated, structurally embedded telemetry compression system capable of intelligent, adaptive, and verifiable data reduction without compromising digital twin fidelity.

The rapid evolution of cyber-physical systems, embedded computing platforms, and intelligent industrial machinery has driven widespread adoption of digital twin technologies for real-time monitoring, predictive maintenance, and operational optimization. Digital twins rely on continuous streams of telemetry data generated by physical devices to maintain synchronized virtual representations of hardware behavior, firmware execution states, and environmental interactions. These telemetry streams typically originate from heterogeneous sources, including sensors embedded within hardware components, firmware-level execution logs, register state traces, timing counters, power consumption monitors, and event-driven interrupt signals. As devices become more complex and operate at higher frequencies, the volume, velocity, and dimensionality of telemetry data have increased exponentially, placing significant strain on data transmission infrastructures and computational resources responsible for digital twin synchronization.

Existing digital twin telemetry systems predominantly rely on raw or lightly processed telemetry transmission models, where large volumes of data are streamed continuously from devices to centralized servers, cloud platforms, or supervisory controllers. While such approaches preserve high-fidelity monitoring, they introduce substantial bandwidth consumption, increased latency, and elevated energy usage, particularly in distributed environments such as industrial IoT networks, edge computing systems, and remote monitoring scenarios. These limitations are exacerbated in environments with constrained communication links, such as wireless industrial networks, satellite-based telemetry systems, and battery-powered embedded devices, where excessive data transmission directly impacts system reliability and operational lifespan.

To mitigate bandwidth constraints, conventional telemetry compression techniques have been employed, typically based on general-purpose data compression techniques such as lossless entropy coding, dictionary-based compression, or fixed-ratio lossy compression schemes. These methods, however, are largely agnostic to the semantic structure of telemetry data and fail to account for the contextual significance of specific hardware or firmware states. As a result, they often compress telemetry uniformly, without distinguishing between critical operational signals and low-value redundant data, leading either to insufficient compression efficiency or to loss of diagnostically relevant information when aggressive compression is applied.

Another class of existing solutions involves edge-based preprocessing, where telemetry data is filtered or aggregated before transmission. In such systems, simple threshold-based filtering or periodic sampling reduction is used to limit data volume. While this approach reduces transmission load, it introduces rigid configurations that do not adapt dynamically to changing device conditions, operational modes, or fault scenarios. Critical transient events may be missed due to coarse sampling intervals, and static filtering rules may suppress early indicators of anomalies, undermining the reliability of digital twin models and predictive analytics.

More advanced solutions have introduced machine learning-based telemetry analysis at centralized servers, where historical telemetry data is analyzed to identify patterns, anomalies, or predictive trends. Although these systems improve insight extraction, they still rely on transmitting large quantities of raw telemetry from devices to central locations before analysis can occur. This architecture inherently limits scalability and responsiveness, as the computational burden and network traffic grow linearly with the number of monitored devices. Furthermore, delayed analysis due to transmission latency reduces the effectiveness of real-time monitoring and rapid fault response, particularly in safety-critical systems.

Certain prior-art systems propose adaptive compression strategies that adjust compression ratios based on network conditions or predefined device profiles. While such systems represent an improvement over static compression, they often operate as external software layers or gateway-based solutions rather than being structurally integrated into the monitored device. This separation introduces delays between telemetry generation and compression decision-making, preventing fine-grained, real-time adaptation based on instantaneous hardware or firmware behavior. Additionally, gateway-centric compression architectures become single points of failure and limit the system's ability to scale across highly distributed device networks.

Existing telemetry management frameworks also tend to treat hardware telemetry and firmware telemetry as independent data streams, applying separate compression or filtering rules to each. This fragmented approach overlooks the intrinsic coupling between hardware behavior and firmware execution, such as timing relationships between sensor readings and control logic, or correlations between power consumption patterns and software execution paths. The absence of unified hardware-firmware co-monitoring reduces the fidelity of digital twin models and impairs the system's ability to diagnose root causes of anomalies that span both physical and logical layers.

Security and data integrity concerns further complicate existing solutions. Many compression and preprocessing systems do not incorporate built-in mechanisms to validate the integrity or reconstructability of compressed telemetry data. As telemetry is reduced, there is often no assurance that the compressed representation retains sufficient information to accurately reconstruct device state or support forensic analysis after an incident. In distributed and adversarial environments, this lack of validation increases susceptibility to data tampering, spoofing, or silent data corruption, undermining trust in digital twin outputs.

Energy efficiency is another critical drawback of current telemetry handling approaches. Continuous transmission of high-volume telemetry data consumes substantial power, particularly in battery-operated or energy-harvesting devices. Even when compression is applied, conventional techniques may impose significant computational overhead, offsetting the energy savings gained from reduced transmission size. Many existing systems lack adaptive mechanisms to balance computational cost against transmission savings in real time, resulting in suboptimal energy utilization across varying operational conditions.

Scalability challenges also persist in state-of-the-art solutions. As the number of monitored devices increases, centralized telemetry processing architectures struggle to handle the aggregate data load, leading to congestion, delayed processing, and increased infrastructure costs. Cloud-centric models require substantial backend resources to store, process, and analyze telemetry data, while also introducing dependencies on network availability and external service reliability. These factors limit the practicality of deploying digital twin monitoring at scale across large industrial installations, smart cities, or nationwide infrastructure systems.

Furthermore, most existing solutions focus on software-level implementations, offering limited consideration for the physical structure of the monitored device itself. Telemetry compression and management are rarely treated as first-class architectural elements within the device design. This omission prevents tight coupling between telemetry handling and device operation, such as leveraging firmware execution context, hardware interrupt timing, or power state transitions to inform compression decisions. The lack of structural integration results in reactive rather than proactive telemetry optimization.

While existing digital twin telemetry solutions have advanced monitoring capabilities, they suffer from fundamental limitations related to bandwidth inefficiency, lack of contextual awareness, insufficient hardware-firmware integration, limited adaptability, energy inefficiency, scalability constraints, and inadequate validation mechanisms. These drawbacks highlight the need for a structurally integrated, on-device telemetry compression system that intelligently adapts to device behavior, co-monitors hardware and firmware states, validates compressed data integrity, and optimizes transmission in real time. Addressing these challenges is essential for enabling reliable, scalable, and energy-efficient digital twin monitoring in next-generation intelligent systems.

### SUMMARY OF THE INVENTION

The present invention discloses a digital twin telemetry compression system implemented as a dedicated on-device machine structure that performs intelligent telemetry reduction for simultaneous hardware and firmware co-monitoring. The system structurally integrates telemetry acquisition interfaces, compression processing circuitry, adaptive precision control logic, and validation pathways into a unified device-resident architecture. The disclosed invention dynamically analyzes telemetry characteristics, operational context, and temporal patterns to generate compressed telemetry representations optimized for bandwidth efficiency, power consumption, and monitoring accuracy.

The invention further provides a machine structure wherein telemetry compression is executed prior to transmission, using adaptive multi-layer compression logic that preserves diagnostic relevance while eliminating redundancy. The system incorporates internal validation pathways to ensure telemetry integrity and enables synchronized digital twin updates with minimal data overhead. By embedding compression intelligence directly within the monitored device, the invention achieves continuous digital twin synchronization, real-time co-monitoring, and scalable deployment across heterogeneous device environments.

An object of the present invention is to provide an advanced digital twin telemetry compression system that overcomes the limitations of conventional telemetry transmission architectures by enabling intelligent, on-device reduction of telemetry data while preserving the semantic and operational fidelity required for accurate digital twin synchronization. The invention aims to ensure that continuous hardware and firmware telemetry can be efficiently managed within constrained bandwidth and power environments without compromising real-time monitoring accuracy or device observability.

Another object of the invention is to achieve unified co-monitoring of hardware-level signals and firmware execution states through a single, integrated telemetry compression architecture. By correlating physical device behavior with firmware-level operational context prior to data transmission, the invention seeks to enhance the diagnostic value of telemetry data and enable more precise identification of anomalies, faults, and performance degradations within complex cyber-physical systems.

A further object of the invention is to provide an adaptive telemetry compression mechanism that dynamically adjusts compression precision, data granularity, and transmission frequency based on real-time device conditions, operational modes, and communication constraints. The invention is intended to eliminate rigid, static compression rules and instead support continuous self-optimization that responds intelligently to variations in workload, network availability, and device criticality.

Another object of the invention is to minimize bandwidth consumption and transmission latency associated with digital twin data synchronization by performing context-aware compression directly within the monitored device. By reducing the volume of telemetry data prior to transmission, the invention seeks to improve scalability of digital twin deployments across large numbers of distributed devices and reduce dependence on high-capacity communication infrastructure.

An additional object of the invention is to improve energy efficiency of telemetry handling in embedded and resource-constrained devices by balancing computational compression cost against transmission energy savings. The invention aims to extend operational lifetime of battery-powered or energy-harvesting devices by intelligently managing telemetry processing and transmission activities in alignment with device power states and energy availability.

Another object of the invention is to ensure integrity, consistency, and reconstructability of compressed telemetry data through built-in validation mechanisms. The invention seeks to guarantee that compressed telemetry retains sufficient informational content to support accurate digital twin reconstruction, post-event analysis, and forensic evaluation, thereby increasing trustworthiness of monitoring outputs.

A further object of the invention is to provide a structurally integrated telemetry compression device that can be embedded within or coupled to existing hardware platforms without requiring extensive redesign of device architecture. The invention aims to support seamless integration with diverse hardware configurations, firmware environments, and digital twin platforms while maintaining interoperability with existing monitoring and communication protocols.

Another object of the invention is to enable scalable deployment of digital twin monitoring systems across industrial, IoT, automotive, medical, and critical infrastructure environments. The invention seeks to support heterogeneous device ecosystems by providing a flexible and configurable compression framework capable of accommodating varying telemetry densities, operational requirements, and monitoring priorities.

An additional object of the invention is to facilitate real-time and near-real-time monitoring capabilities by reducing telemetry processing delays and enabling rapid synchronization between physical devices and their corresponding digital twins. The invention aims to enhance responsiveness in safety-critical and mission-critical applications where timely detection of abnormal conditions is essential.

Yet another object of the invention is to establish a foundation for continuous improvement of telemetry handling through learning-based adaptation and historical telemetry analysis. The invention seeks to enable progressive refinement of compression strategies over time, allowing the telemetry compression system to evolve in response to changing device behavior, environmental conditions, and operational demands, thereby ensuring long-term effectiveness and robustness of digital twin monitoring systems.

### BRIEF DESCRIPTION OF FIGURES

These and other features, aspects, and advantages of the present invention will become better understood when the following detailed description is read concerning the accompanying drawings in which like characters represent like parts throughout the drawings, wherein:

FIG. 1 displays a block diagram of a digital twin telemetry compression system configured for on-device co-monitoring of hardware and firmware states; and

FIG. 2 displays flow chart of a method for digital twin telemetry compression for on-device co-monitoring of hardware and firmware states.

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having benefit of the description herein.

### DETAILED DESCRIPTION OF THE INVENTION

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present disclosure will be described below in detail with reference to the accompanying drawings.

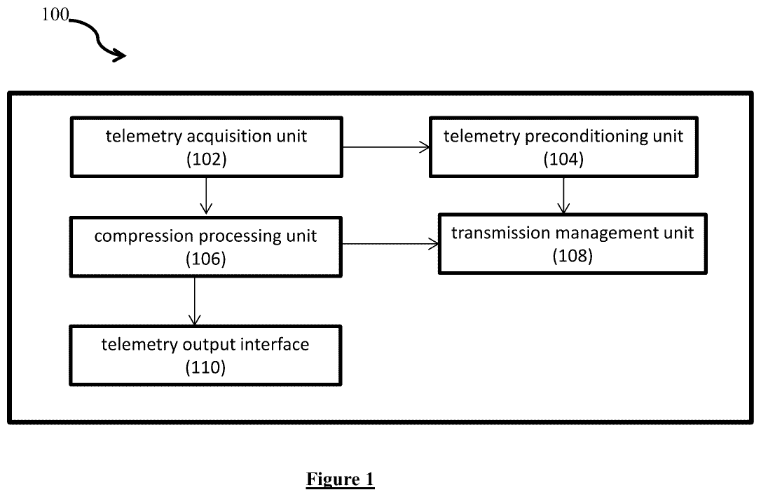

Referring to FIG. 1, a block diagram of a system for a digital twin telemetry compression system configured for on-device co-monitoring of hardware and firmware states is illustrated. The system 100 comprises: a telemetry acquisition unit (102) physically coupled to at least one hardware sensing interface and at least one firmware execution observation interface of a monitored device, the telemetry acquisition unit being configured to continuously collect multi-dimensional telemetry signals representing physical operating conditions and firmware execution behavior; a telemetry preconditioning unit (104) operatively connected to the telemetry acquisition unit and configured to normalize, timestamp, and structurally align the collected telemetry signals into correlated hardware-firmware telemetry sequences; a compression processing unit (106) operatively connected to the telemetry preconditioning unit and comprising at least one processor and at least one non-transitory memory, the compression processing unit being configured to analyze temporal stability, variance characteristics, and cross-layer correlation of the correlated telemetry sequences and to generate compressed telemetry representations by adaptively adjusting data precision, aggregation granularity, and temporal resolution; a transmission management unit (108) operatively connected to the compression processing unit and configured to regulate telemetry output based on available communication bandwidth, device power state, and monitoring priority; and a telemetry output interface (110) configured to transmit the compressed telemetry representations to an external digital twin system, wherein the compression processing unit performs telemetry reduction prior to transmission while preserving reconstructable digital twin state fidelity.

In an embodiment, the telemetry acquisition unit (102) comprises a hardware signal coupling circuit configured to receive electrical, thermal, timing, and power-related signals from physical components of the monitored device, and a firmware observation circuit configured to receive execution state indicators, memory access patterns, and control flow events generated by firmware executing on the monitored device.

In an embodiment, the telemetry preconditioning unit (104) is configured to temporally synchronize hardware telemetry signals and firmware telemetry signals by assigning unified time references and to generate a composite telemetry structure that preserves causal relationships between physical events and firmware execution transitions.

In an embodiment, the compression processing unit (106) is configured to identify telemetry segments exhibiting low temporal entropy and to apply higher compression precision reduction to such segments while maintaining higher data precision for telemetry segments associated with detected state transitions or anomalous behavior.

In an embodiment, the compression processing unit (106) further comprises an adaptive threshold control circuit configured to modify compression parameters in real time based on historical telemetry behavior stored in the non-transitory memory and current operating context of the monitored device.

In an embodiment, the compression processing unit (106) is configured to generate telemetry fingerprints representing structural characteristics of compressed telemetry representations, the telemetry fingerprints being stored locally for subsequent validation and reconstruction verification.

In an embodiment, further comprising a telemetry validation unit operatively connected to the compression processing unit and configured to verify integrity and reconstructability of compressed telemetry representations by comparing generated telemetry fingerprints with expected structural profiles prior to transmission.

In an embodiment, the telemetry validation unit is configured to inhibit transmission of compressed telemetry representations that fail integrity or reconstructability verification and to request recompression with modified precision parameters.

In an embodiment, the transmission management unit (108) is configured to dynamically schedule telemetry transmission frequency based on real-time bandwidth availability and to defer non-critical telemetry segments while prioritizing transmission of telemetry segments associated with detected abnormal operating conditions.

In an embodiment, the compression processing unit (106) is configured to perform compression operations using energy-aware processing sequences that adjust processor utilization and memory access patterns based on current power availability of the monitored device.

In an embodiment, the telemetry acquisition unit is configured to continuously sample the electrical, thermal, timing, and power-related signals through the hardware signal coupling circuit using interrupt-driven acquisition pathways, and to capture the execution state indicators, memory access patterns, and control flow events through the firmware observation circuit using event-triggered monitoring hooks embedded within the firmware execution environment, and wherein the telemetry preconditioning unit is further configured to align the sampled hardware telemetry signals and the captured firmware telemetry signals by assigning unified time references through a common timing reference generator, to correlate temporally adjacent hardware and firmware events by constructing ordered event sequences, and to generate the composite telemetry structure by embedding synchronized event identifiers and temporal offset markers within the unified telemetry representation so as to preserve the causal ordering of physical state changes and firmware execution transitions.

In an embodiment, the telemetry acquisition unit operates by interfacing directly with multiple sensing pathways associated with the monitored device so that variations in electrical levels, thermal conditions, timing pulses, and power consumption are captured in real time as they occur within the physical environment of the device. The hardware signal coupling circuit is implemented to receive these signals through dedicated sensing interfaces that respond to signal fluctuations by generating interrupts, thereby initiating immediate sampling without requiring continuous processor polling. This interrupt-driven acquisition allows the system to capture transient physical events such as sudden current surges, localized heating, or timing irregularities at the precise moment they occur. In parallel, the firmware observation circuit is embedded within the firmware execution environment and is structured to register execution state transitions, memory access behaviors, and control flow changes by observing instruction execution boundaries, stack operations, and memory transaction activities. For instance, when firmware switches from a normal operating loop to a fault-handling routine, the observation circuit records the change in execution context along with memory access intensity and control transfer behavior.

The telemetry preconditioning unit receives the hardware and firmware-derived streams and aligns them by assigning a unified time reference generated from a common timing source. Each captured event is stamped with a synchronized time indicator, allowing the system to place hardware-originated changes and firmware-execution transitions within a single chronological sequence. This alignment enables the construction of ordered event sequences in which temporally adjacent physical and firmware events are correlated based on proximity in time. For example, if a rise in processor temperature occurs simultaneously with increased memory access frequency and a shift in execution control flow, these events are grouped together in sequence to form a coherent representation of system behavior. The composite telemetry structure is then generated by embedding synchronized event identifiers and temporal offset markers into the unified telemetry representation, where the identifiers distinguish event types and the offset markers indicate precise temporal relationships between them. This structured representation preserves the cause-and-effect relationship between physical state variations and firmware execution changes, allowing downstream processing components to interpret not only what events occurred but also how one event influenced another. As a result, the system is capable of reconstructing detailed operational histories, improving the accuracy of behavior analysis, enabling reliable detection of abnormal operating conditions, and ensuring that correlated hardware and firmware interactions are captured with high temporal fidelity.

In an embodiment, the telemetry preconditioning unit is configured to detect and correct timing inconsistencies between the hardware telemetry signals and the firmware telemetry signals by identifying temporal discontinuities and applying compensatory time offset adjustments, and further configured to segment the composite telemetry structure into causally coherent telemetry blocks by grouping synchronized physical and firmware events occurring within predefined temporal windows, the telemetry blocks being structured to retain inter-event dependencies and contextual relationships required for downstream compression and validation operations.

In an embodiment, the telemetry preconditioning unit operates by continuously examining the time-stamped hardware-derived signals and firmware-derived event records to identify inconsistencies that arise due to differences in acquisition latency, processing delay, or asynchronous event reporting. Such inconsistencies may appear as irregular gaps between expected event intervals, misalignment between related hardware and firmware events, or overlapping timestamps that disrupt chronological ordering. The unit detects these temporal discontinuities by comparing successive event timestamps and determining whether the observed intervals deviate from expected temporal patterns associated with normal device operation. Upon identifying such deviations, the unit applies compensatory time offset adjustments by recalibrating the affected timestamps using reference points derived from the unified timing source and adjacent synchronized events. For example, if a firmware execution transition is recorded slightly later than a corresponding electrical fluctuation due to processing latency, the system adjusts the timestamp of the firmware event so that both events are aligned within the same temporal context, restoring the correct sequence of occurrence.

Following correction of these inconsistencies, the telemetry preconditioning unit organizes the aligned telemetry stream into causally coherent telemetry blocks by grouping together physical and firmware events that occur within predefined temporal windows. These windows are determined based on the typical response times and interaction characteristics of the monitored device, ensuring that events likely to be related are captured within the same block. Each telemetry block therefore contains a set of synchronized signals and execution indicators that reflect a single operational context, such as a processing cycle, a power fluctuation response, or a memory-intensive operation. Within each block, the unit preserves inter-event dependencies by maintaining the relative timing, sequence, and correlation between events, ensuring that contextual relationships are retained for subsequent processing. For instance, a telemetry block may contain a sequence where a voltage dip is followed by a firmware control flow adjustment and a timing delay; preserving this sequence allows later stages to interpret the events as part of a single operational reaction rather than independent occurrences. By structuring the telemetry in this manner, the system maintains a coherent representation of device behavior that supports accurate compression, reliable validation, and faithful reconstruction of operational scenarios.

In an embodiment, the compression processing unit is configured to determine the telemetry segments exhibiting low temporal entropy by calculating variation metrics across consecutive telemetry samples within each telemetry segment, to dynamically assign compression precision levels based on the calculated variation metrics, and to selectively retain higher-resolution representations for telemetry segments associated with detected state transitions by identifying abrupt changes in signal amplitude, execution state variation, or control flow deviations within the composite telemetry structure.

In an embodiment, the compression processing unit operates by examining the composite telemetry structure as a continuous sequence of time-ordered samples and dividing the incoming data into segments that represent short operational intervals of the monitored device. Within each segment, the unit evaluates variation metrics by comparing consecutive samples to determine the degree of change in signal amplitude, frequency of state updates, and consistency of firmware execution patterns. This evaluation may involve computing the rate of change between adjacent values, measuring the repetition of similar values across time, and identifying stability in execution behavior reflected through repeated control flow paths or uniform memory access activity. Segments that exhibit minimal change over time, such as stable voltage levels, consistent temperature readings, or repetitive firmware loop execution, are classified as having low temporal entropy. These segments are then assigned higher compression precision reduction because the underlying information content remains largely unchanged and can be represented efficiently using fewer retained data points while still allowing accurate reconstruction.

In contrast, when the compression processing unit detects abrupt changes in signal amplitude, rapid shifts in execution state, or irregular control flow transitions within a segment, it interprets these as indications of a state transition or operational anomaly. Such changes are identified through threshold-based variation detection, where sudden spikes in current consumption, rapid thermal gradients, or unexpected jumps in execution state markers are recognized as events requiring preservation of detail. For example, a transition from an idle firmware state to an intensive computation routine may be accompanied by increased memory activity and a rise in power usage; these correlated changes cause the segment to be flagged as high variation. In such cases, the compression processing unit dynamically assigns a higher precision level to that segment by retaining more granular telemetry samples, preserving intermediate values, and reducing data reduction intensity. This adaptive precision allocation ensures that important operational transitions are captured with sufficient detail for later interpretation.

By continuously adjusting compression precision based on calculated variation metrics, the system balances efficient data reduction with accurate retention of meaningful operational information. Stable segments are compactly encoded without losing essential context, while segments associated with significant behavioral changes are preserved with enhanced detail, enabling precise reconstruction of events such as fault conditions, performance fluctuations, or execution anomalies. This approach improves the fidelity of stored telemetry while reducing storage and transmission requirements, and ensures that transitions in device behavior remain traceable and analyzable in subsequent validation and monitoring processes.

In an embodiment, the adaptive threshold control circuit is configured to continuously monitor historical telemetry behavior stored in the non-transitory memory and to derive context-sensitive compression thresholds by correlating prior telemetry variation patterns with current operating context indicators, and further configured to modify compression parameters in real time by adjusting precision reduction levels, sampling retention intervals, and data encoding density based on detected changes in device workload intensity, operational stability, and power consumption characteristics.

In an embodiment, the adaptive threshold control circuit operates by maintaining access to previously recorded telemetry stored in the non-transitory memory and continuously analyzing patterns that represent how the monitored device has behaved under different operating conditions over time. The circuit examines stored telemetry variation characteristics such as signal stability ranges, frequency of execution transitions, typical power usage fluctuations, and timing irregularities observed during earlier operational states. These historical variation patterns are then compared with the current incoming telemetry to identify similarities in operating context, such as whether the device is in an idle condition, under sustained computational load, transitioning between operational modes, or experiencing fluctuating power availability. By establishing this correlation, the circuit determines context-sensitive compression thresholds that are not fixed but instead reflect how much variation is normally expected in a given state of operation.

When the device enters a state that historically corresponds to stable behavior, such as a prolonged steady processing loop with consistent thermal and electrical profiles, the circuit dynamically increases the permissible precision reduction levels and extends sampling retention intervals so that redundant data points are removed without compromising interpretability. Conversely, when the current telemetry indicates changes in workload intensity, such as a rapid increase in processing activity reflected through higher memory access frequency and increased power consumption, the circuit lowers the compression threshold so that more granular data is retained. Similarly, if operational stability decreases, as indicated by irregular execution state transitions or unpredictable timing patterns, the circuit modifies data encoding density to preserve additional structural detail within the telemetry stream. For example, if prior telemetry records show that sudden power consumption spikes typically precede execution instability, the circuit uses that correlation to proactively retain higher-resolution samples during similar current conditions.

This real-time modification of compression parameters allows the compression processing unit to adapt its behavior continuously in response to changing device conditions, ensuring that periods of stability are efficiently represented while periods of variability are captured with greater detail. The process improves consistency in data representation across different operational contexts and allows the system to maintain meaningful telemetry fidelity without relying on static compression settings. As a result, the telemetry data remains sufficiently detailed during critical operational phases while achieving effective reduction during routine conditions, supporting accurate analysis and reliable reconstruction of device behavior over time.

In an embodiment, the compression processing unit is configured to generate the telemetry fingerprints by extracting structural attributes from the compressed telemetry representations including segment boundaries, temporal density distributions, data continuity signatures, and encoded event correlation markers, and to construct a structural fingerprint descriptor by combining the extracted structural attributes into a compact representation that uniquely characterizes the internal organization of the compressed telemetry representations.

In an embodiment, the compression processing unit is structured to analyze the internal composition of each compressed telemetry representation after the compression stage has been completed, and to extract identifiable structural attributes that reflect how the telemetry data is organized rather than the raw signal values themselves. These attributes include the delineation of segment boundaries that indicate where distinct telemetry portions begin and end, the temporal density distribution that reflects how frequently events occur within a given interval, continuity signatures that indicate whether data points follow a stable progression or exhibit breaks or abrupt transitions, and encoded event correlation markers that preserve relationships between synchronized hardware and firmware events. The unit processes these attributes by scanning the compressed representation to detect patterns such as repeated sequences, spacing between event markers, and alignment of correlated event identifiers embedded during earlier processing stages.

Once these structural attributes are identified, the compression processing unit combines them into a compact structural fingerprint descriptor by encoding the arrangement, sequence, and relative positioning of these attributes into a condensed format that captures the organizational pattern of the telemetry representation. For example, a telemetry segment representing a stable operational period may produce a fingerprint showing evenly spaced event markers, consistent segment boundaries, and continuous data progression, whereas a segment associated with rapid state transitions may produce a fingerprint with dense event clustering, irregular boundary spacing, and distinct correlation markers. The resulting descriptor acts as a unique structural identity for the compressed telemetry, enabling later comparison without requiring access to the full original dataset.

This process allows the system to preserve a summary of how the telemetry was structured at the time of compression, which supports reliable validation, verification, and reconstruction activities in subsequent stages. By representing the internal organization of the compressed data in a compact form, the system enables efficient detection of structural deviations, maintains consistency across repeated telemetry capture cycles, and ensures that important relationships between synchronized events remain traceable even after data reduction has been applied.

In an embodiment, the telemetry validation unit is configured to verify integrity and reconstructability of the compressed telemetry representations by retrieving the telemetry fingerprints stored locally, comparing structural attributes of a newly generated compressed telemetry representation with corresponding attributes of the stored telemetry fingerprints, and identifying deviations indicative of data loss, corruption, or structural inconsistency prior to authorizing transmission of the compressed telemetry representations.

In an embodiment, the compression processing unit is structured to analyze the internal composition of each compressed telemetry representation after the compression stage has been completed, and to extract identifiable structural attributes that reflect how the telemetry data is organized rather than the raw signal values themselves. These attributes include the delineation of segment boundaries that indicate where distinct telemetry portions begin and end, the temporal density distribution that reflects how frequently events occur within a given interval, continuity signatures that indicate whether data points follow a stable progression or exhibit breaks or abrupt transitions, and encoded event correlation markers that preserve relationships between synchronized hardware and firmware events. The unit processes these attributes by scanning the compressed representation to detect patterns such as repeated sequences, spacing between event markers, and alignment of correlated event identifiers embedded during earlier processing stages.

Once these structural attributes are identified, the compression processing unit combines them into a compact structural fingerprint descriptor by encoding the arrangement, sequence, and relative positioning of these attributes into a condensed format that captures the organizational pattern of the telemetry representation. For example, a telemetry segment representing a stable operational period may produce a fingerprint showing evenly spaced event markers, consistent segment boundaries, and continuous data progression, whereas a segment associated with rapid state transitions may produce a fingerprint with dense event clustering, irregular boundary spacing, and distinct correlation markers. The resulting descriptor acts as a unique structural identity for the compressed telemetry, enabling later comparison without requiring access to the full original dataset.

This process allows the system to preserve a summary of how the telemetry was structured at the time of compression, which supports reliable validation, verification, and reconstruction activities in subsequent stages. By representing the internal organization of the compressed data in a compact form, the system enables efficient detection of structural deviations, maintains consistency across repeated telemetry capture cycles, and ensures that important relationships between synchronized events remain traceable even after data reduction has been applied.

In an embodiment, the telemetry validation unit is further configured to request recompression with modified precision parameters by transmitting control instructions to the compression processing unit specifying adjusted compression precision levels and retention parameters when structural inconsistencies are detected, and wherein the compression processing unit is configured to recompress the affected telemetry segments by selectively restoring previously reduced precision levels and regenerating the telemetry fingerprints for subsequent validation.

In an embodiment, the telemetry validation unit operates as an active supervisory component that evaluates the structural consistency of compressed telemetry representations and initiates corrective action when inconsistencies are detected. Upon identifying deviations between expected structural attributes and those present in a newly generated compressed representation, the validation unit generates and transmits control instructions to the compression processing unit. These instructions include revised precision parameters that specify how much detail should be retained for the affected telemetry segments, as well as retention adjustments that determine the extent to which previously discarded intermediate samples should be restored. The control instructions are conveyed through an internal control interface that enables the compression processing unit to isolate only the affected telemetry segments without altering segments that have already passed validation.

In response to the received instructions, the compression processing unit accesses stored intermediate representations or buffered telemetry data associated with the affected segments and selectively restores precision that was previously reduced during initial compression. This restoration may involve reintegrating omitted sample points, recalculating compressed values using narrower reduction margins, and re-encoding temporal alignment information to ensure continuity of event sequences. For example, if the validation unit determines that an event correlation marker was partially degraded due to aggressive compression, the recompression process increases the retained detail around that marker and regenerates the segment with improved structural integrity. After recompression, the unit extracts structural attributes again and generates updated telemetry fingerprints reflecting the revised internal organization of the compressed data.

The regenerated fingerprints are then provided back to the validation unit for subsequent verification to confirm that the structural relationships between events, segment boundaries, and continuity indicators are now preserved. This iterative correction mechanism allows the system to recover from compression-induced distortions while maintaining efficient data reduction. By selectively restoring precision only where structural inconsistencies are identified, the system avoids unnecessary processing overhead while ensuring that telemetry representations remain suitable for accurate reconstruction and analysis, particularly in segments associated with operational transitions or irregular behavior.

In an embodiment, the transmission management unit is configured to dynamically schedule telemetry transmission frequency by continuously monitoring bandwidth utilization levels and communication channel availability, to classify telemetry segments as critical or non-critical based on the presence of abnormal operating conditions identified within the composite telemetry structure, and to assign higher transmission priority to telemetry segments containing synchronized physical and firmware events associated with anomalous operational behavior.

In an embodiment, the transmission management unit operates by continuously observing communication parameters associated with the outgoing telemetry link, including instantaneous bandwidth usage, channel occupancy duration, packet acknowledgment intervals, and transmission latency patterns. These parameters are evaluated in real time to determine the current availability of the communication channel and to calculate a suitable transmission schedule that adapts to fluctuating network conditions. When bandwidth availability is high and the communication channel is stable, the unit increases the frequency of telemetry transmissions to maintain near real-time reporting. Conversely, during periods of congestion, reduced throughput, or intermittent connectivity, the unit reduces transmission frequency and selectively queues telemetry segments for deferred delivery, thereby preventing overload of the communication pathway and avoiding unnecessary retransmissions.

Simultaneously, the transmission management unit analyzes the composite telemetry structure to classify telemetry segments according to their operational relevance. This classification is performed by examining synchronized hardware and firmware event sequences for patterns that indicate abnormal operating conditions, such as unexpected thermal rises paired with irregular control flow transitions, sudden power fluctuations accompanied by timing disruptions, or execution state changes that deviate from established patterns. Segments containing such correlated anomalies are marked as critical, while segments representing stable, repetitive, or predictable behavior are categorized as non-critical. For instance, if a telemetry segment reflects a coordinated occurrence of increased power consumption, memory access spikes, and execution path divergence, that segment is recognized as indicative of a potential fault or performance anomaly and is designated for immediate transmission.

Based on this classification, the transmission management unit assigns dynamic priority levels to outgoing telemetry segments. Critical segments are transmitted at higher priority with reduced scheduling delay, ensuring that time-sensitive information reflecting abnormal behavior is delivered promptly for monitoring or intervention purposes. Non-critical segments are scheduled with lower priority and may be transmitted at longer intervals or combined into batch transmissions to optimize channel usage. The scheduling process adjusts continuously in response to both network conditions and device operational state, allowing the system to maintain efficient data flow while ensuring that significant telemetry events receive timely attention. This coordinated prioritization and adaptive scheduling approach enables consistent reporting of meaningful operational changes without overwhelming communication resources, thereby supporting reliable remote monitoring and responsive system oversight.

In an embodiment, the compression processing unit is configured to perform the energy-aware processing sequences by modulating processor activity cycles and memory access frequency in response to the current power availability of the monitored device, to temporarily defer non-essential compression operations during periods of reduced power availability, and to execute prioritized compression of telemetry segments associated with detected abnormal operating conditions while maintaining reduced processing load for routine telemetry segments.

In an embodiment, the compression processing unit is designed to continuously monitor indicators associated with the current power availability of the monitored device, such as voltage stability, current draw patterns, and internal power management signals, and to regulate its internal processing behavior accordingly. The unit adjusts processor activity cycles by dynamically scaling the duration and frequency of active computation intervals so that compression tasks are executed in shorter bursts when power levels are constrained and in longer sustained cycles when sufficient power is available. At the same time, the frequency of memory access operations is modulated to reduce repeated read and write activity during low-power conditions, thereby lowering the instantaneous processing demand placed on the device. This controlled modulation allows the system to continue performing essential telemetry handling functions without causing excessive strain on the power source.

During periods when reduced power availability is detected, the compression processing unit selectively defers compression tasks that are not immediately required for preserving operational awareness. Routine telemetry segments representing stable conditions, repetitive operational patterns, or non-critical environmental readings are temporarily stored in intermediate memory buffers without undergoing immediate compression. This deferral mechanism ensures that processing resources are conserved and that the system avoids interruptions or slowdowns in core monitoring activities. In contrast, telemetry segments that reflect abnormal operating conditions, such as sudden changes in execution state, unexpected fluctuations in electrical or thermal signals, or irregular timing behavior, are identified and assigned priority for immediate compression. For example, if a drop in supply voltage coincides with unusual firmware activity, the corresponding telemetry segment is compressed promptly despite limited power availability so that the relevant information is preserved in a structured form.

By maintaining a reduced processing load for routine segments while prioritizing segments associated with unusual behavior, the compression processing unit sustains continuous monitoring capability even under constrained energy conditions. This adaptive control over processor utilization and memory access activity enables the device to maintain consistent telemetry capture and processing without causing additional power instability. As a result, the system preserves detailed records of critical operational changes while efficiently managing computational effort during periods of limited energy availability, ensuring that essential data remains available for analysis without compromising the stability of the monitored device.

In an embodiment, the compression processing unit is further configured to monitor instantaneous power consumption patterns of the monitored device and to adjust data handling operations by redistributing compression workloads across multiple processing intervals, selectively buffering telemetry segments in the non-transitory memory during low power conditions, and initiating deferred compression cycles upon detection of restored power availability so as to maintain continuity of telemetry processing without interrupting ongoing monitoring functions.

In an embodiment, the compression processing unit continuously observes instantaneous power consumption patterns of the monitored device by interfacing with internal power monitoring signals that reflect short-term fluctuations in current draw, voltage stability, and power delivery consistency. These measurements are evaluated over successive short intervals to identify transient low-power states, sustained reductions in available power, or recovery phases where power levels return to normal. Based on this ongoing assessment, the compression processing unit dynamically adjusts how compression tasks are distributed over time rather than executing all compression operations immediately upon telemetry capture. When power availability begins to decline, the unit reduces the intensity of active compression activity by redistributing the workload into smaller processing portions that are scheduled across multiple intervals, thereby preventing sudden spikes in processor utilization and avoiding additional strain on the device's power resources.

During periods identified as low-power conditions, incoming telemetry segments continue to be acquired and are selectively stored in the non-transitory memory in their pre-compressed or partially processed form. The buffering process is managed so that segments are indexed with temporal markers and contextual identifiers to preserve the sequence and interdependence of events while awaiting later processing. For example, if a device experiences a temporary reduction in available power during a sequence of firmware-driven operations, the associated telemetry samples capturing electrical, thermal, and execution activity are safely retained in memory with their timing relationships intact. This ensures that monitoring continuity is not interrupted even when compression cannot be performed immediately.

Once the compression processing unit detects that power availability has stabilized or improved, deferred compression cycles are initiated to process the buffered telemetry segments. These deferred cycles are executed in an ordered manner, starting with the oldest buffered segments to maintain chronological consistency. The unit applies compression gradually so that processing load increases in a controlled fashion, preventing sudden surges in energy consumption. By redistributing compression workloads and using temporary buffering during low-power phases, the system maintains uninterrupted telemetry acquisition and preserves complete operational histories without sacrificing data integrity. This approach allows continuous monitoring to proceed independently of fluctuating power conditions while ensuring that all captured telemetry is eventually compressed and structured for storage or transmission, maintaining a consistent and reliable record of device behavior across varying energy states.

In an embodiment, the telemetry acquisition unit is further configured to establish event-linked sampling of the electrical, thermal, timing, and power-related signals by activating the hardware signal coupling circuit in response to detected changes in the execution state indicators captured by the firmware observation circuit, and wherein the telemetry preconditioning unit is configured to embed event association markers within the composite telemetry structure to explicitly link hardware-originated signal variations with corresponding firmware execution transitions occurring within a correlated temporal interval.

In an embodiment, the telemetry acquisition unit operates in a coordinated manner with the firmware observation circuit to enable event-linked sampling in which physical signal capture is triggered by meaningful changes in firmware activity rather than relying solely on continuous sampling intervals. The firmware observation circuit monitors execution state indicators such as transitions between operational routines, changes in control flow direction, and variations in memory access behavior. When such a transition is detected, a trigger signal is generated internally and routed to the hardware signal coupling circuit, causing it to initiate targeted acquisition of electrical, thermal, timing, and power-related signals at that precise moment. This approach ensures that hardware signal sampling is concentrated around periods of active firmware change, allowing the system to capture the physical impact of software-driven operations with greater temporal relevance. For instance, when firmware shifts from a low-activity state to a processing-intensive task, the triggering mechanism causes immediate sampling of power consumption and thermal signals so that the physical response of the device is recorded at the onset of the transition.

The telemetry preconditioning unit receives the hardware signals acquired in response to these triggers along with the corresponding execution state information captured by the firmware observation circuit. It then embeds event association markers into the composite telemetry structure to explicitly represent the relationship between each firmware execution transition and the related physical signal variations occurring within a defined temporal interval. These markers are structured to identify the specific firmware event that initiated the hardware sampling, as well as the relative timing between the execution transition and the observed physical response. For example, if a control flow change leads to increased processor utilization followed by a rise in temperature and power draw, the system inserts association markers linking the execution event to the subsequent hardware signal changes. By preserving this linkage, the resulting telemetry representation captures not only the occurrence of individual events but also the interaction between software behavior and physical system response.

This coordinated event-linked sampling mechanism enables more precise correlation between firmware-driven actions and their physical effects, improving the clarity of operational insights derived from the telemetry. The system is able to focus data acquisition around meaningful execution changes, reduce redundant sampling during stable periods, and produce a structured telemetry stream in which cause-and-response relationships are explicitly maintained. As a result, later analysis and reconstruction processes can accurately interpret how firmware activities influence physical device behavior, leading to a more reliable and context-rich representation of the monitored system's operational state.

In an embodiment, the compression processing unit is further configured to perform context-adaptive segmentation of the composite telemetry structure by dividing the telemetry into dynamically determined segments based on detected signal stability, execution continuity, and temporal density of event occurrence, and to apply differentiated compression operations to each dynamically determined segment by selectively adjusting data precision retention, encoding density, and segment boundary preservation based on the operational context represented within each segment.

In an embodiment, the compression processing unit processes the composite telemetry structure as a continuously evolving stream and identifies natural separation points for segmentation by examining characteristics such as signal stability over time, continuity in firmware execution patterns, and the temporal density of recorded events. The unit evaluates the rate of change in electrical, thermal, timing, and power-related signals along with the persistence or transition of execution states to determine whether the system is operating in a stable condition, undergoing gradual variation, or experiencing rapid transitions. Based on this evaluation, dynamically determined segments are formed, where stable intervals containing repetitive or slowly changing signals are grouped into one segment, and intervals containing frequent execution shifts, abrupt signal fluctuations, or dense event activity are grouped into separate segments. For example, a period during which firmware repeatedly executes a steady operational loop with minimal variation in power consumption is treated as a stable segment, whereas a period involving frequent control flow changes and rapid increases in current draw is treated as a transition-intensive segment.

Once segmentation is established, the compression processing unit applies differentiated compression operations tailored to the operational context represented within each segment. For segments characterized by high signal stability and execution continuity, the unit increases data reduction by lowering precision retention, using denser encoding techniques to represent repeated patterns, and preserving only essential boundary markers required to maintain chronological order. In contrast, segments containing dense event occurrences, frequent state transitions, or irregular signal variations are handled with greater preservation of detail. In such segments, the unit selectively retains higher data precision, applies less aggressive encoding density to avoid loss of important intermediate values, and maintains clear segment boundary definitions so that transitions between operational states remain identifiable. For instance, when a segment reflects a sequence where a firmware routine initiates a processing spike followed by a corresponding thermal increase, the compression processing unit preserves more granular data points and clearly marks the start and end of the segment to maintain interpretability.

By dynamically adapting segmentation and compression behavior to the contextual characteristics of each portion of telemetry, the system maintains a balance between efficient data reduction and accurate representation of meaningful operational changes. Stable operational intervals are represented compactly without unnecessary redundancy, while segments reflecting significant behavioral activity are preserved with sufficient detail to support later reconstruction, validation, and analysis. This context-sensitive approach allows the telemetry to retain structural coherence and meaningful event relationships even after compression, enabling consistent interpretation of system behavior across varying operational conditions.

In an embodiment, the telemetry validation unit is configured to perform multi-stage reconstructability verification by simulating partial reconstruction of the compressed telemetry representations using locally stored telemetry fingerprints, identifying structural inconsistencies across reconstructed telemetry segments through comparison of temporal alignment markers and event continuity indicators, and generating validation status signals indicative of reconstructability readiness prior to enabling transmission control through the transmission management unit.

In an embodiment, the telemetry validation unit performs reconstructability verification through a staged internal process that evaluates whether the compressed telemetry representations can be reliably interpreted and restored before they are permitted to proceed to transmission. This is achieved by initiating a controlled partial reconstruction procedure in which selected portions of the compressed telemetry are expanded using the locally stored telemetry fingerprints as structural reference guides. Rather than fully reconstructing the entire telemetry stream, the unit selectively reconstructs representative sections from different segments to determine whether the preserved structural attributes are sufficient to maintain event order, continuity, and contextual relationships. The telemetry fingerprints provide a compact reference of expected segment boundaries, temporal density patterns, and event correlation structures, which the validation unit uses to guide the reconstruction and verify alignment with the original structural arrangement.

During this staged reconstruction process, the validation unit compares the partially reconstructed telemetry segments with the structural expectations defined by the stored fingerprints. This comparison focuses on examining temporal alignment markers that indicate whether events appear in the correct sequence and at the appropriate relative intervals, as well as event continuity indicators that confirm whether related firmware and hardware events remain linked as originally represented. For example, if a reconstructed segment shows a firmware execution transition occurring before a related power fluctuation when the fingerprint indicates the opposite order, the validation unit identifies this as a structural inconsistency. Similarly, if a sequence of correlated events appears fragmented or if segment boundaries are distorted in a way that breaks continuity between related events, the discrepancy is detected through the mismatch between reconstructed data and the fingerprint-derived reference pattern.

Based on these comparisons, the telemetry validation unit generates validation status signals that indicate whether the compressed telemetry representation is suitable for reliable downstream use. A positive status is produced when reconstructed segments maintain correct temporal alignment and event continuity, confirming that the compressed representation retains sufficient structural information for interpretation. If inconsistencies are detected, the validation status reflects that reconstructability readiness has not been achieved, and corrective processes can be initiated before any transmission occurs. By performing this multi-stage verification prior to enabling transmission control, the system ensures that only structurally coherent and interpretable telemetry data is released for communication, reducing the likelihood of transmitting incomplete or misleading representations of device behavior while preserving the fidelity of event relationships captured during monitoring.

In an embodiment, the compression processing unit is further configured to coordinate the energy-aware processing sequences with telemetry acquisition timing by dynamically synchronizing compression execution intervals with periods of reduced telemetry acquisition activity, to temporarily store incoming telemetry segments in the non-transitory memory during active acquisition intervals, and to initiate deferred compression operations during acquisition idle intervals so as to maintain continuous telemetry capture while regulating processor utilization and memory access patterns in accordance with current power availability of the monitored device.

In an embodiment, the compression processing unit operates in coordination with the telemetry acquisition timing by monitoring the rate at which incoming telemetry is being generated and identifying intervals in which acquisition activity is relatively low compared to periods of intensive signal capture. The unit maintains awareness of acquisition cycles by tracking the frequency of interrupt-driven hardware sampling and firmware event capture, and uses this information to determine when system resources are more heavily engaged in collecting telemetry data. During intervals of high acquisition activity, where numerous electrical, thermal, timing, and power-related signals are being sampled in rapid succession along with frequent firmware execution events, the compression processing unit reduces its active processing engagement and temporarily refrains from performing computationally intensive compression tasks. Instead, the incoming telemetry segments are directed into non-transitory memory where they are stored in an organized and time-stamped form that preserves sequence, interdependence, and contextual relevance.

As acquisition activity subsides and the rate of incoming telemetry decreases, the compression processing unit dynamically synchronizes its compression execution intervals with these quieter periods. By initiating compression during these acquisition idle intervals, the unit utilizes available processor capacity without interfering with the primary task of capturing real-time telemetry. For example, when the monitored device transitions from an active operational phase with frequent firmware state changes to a more stable phase with minimal signal variation, the acquisition load naturally reduces. The compression processing unit detects this reduced activity and begins processing the buffered telemetry segments, applying compression in a controlled manner that balances processing intensity with current power availability. The scheduling of these deferred compression cycles is continuously adjusted based on ongoing monitoring of power conditions and acquisition demand, ensuring that compression tasks do not introduce additional load during periods when the device is already handling significant acquisition activity.

This coordinated approach allows continuous telemetry capture to proceed uninterrupted because acquisition pathways are not competing with compression operations for processor time or memory bandwidth during critical intervals. By temporarily storing telemetry segments and executing compression only when acquisition activity is low, the system maintains a steady flow of data collection while regulating processor utilization and memory access patterns in a manner consistent with available energy conditions. As a result, the device sustains reliable monitoring performance, avoids resource contention between acquisition and compression processes, and ensures that all captured telemetry is eventually processed and structured without risking data loss or processing delays during periods of high operational demand.

In an implementation, each functional unit described herein is realized as a dedicated hardware component or a combination of interconnected electronic hardware modules configured to perform the described operations. The telemetry acquisition unit is implemented using physical interfacing circuitry that includes signal reception lines, sensing interfaces, and interrupt-capable acquisition controllers arranged on a circuit board to directly receive electrical, thermal, timing, and power-related signals from the monitored device. The hardware signal coupling circuit is formed by analog and digital interfacing elements that condition and route incoming physical signals through filtering, amplification, and conversion stages to make them suitable for digital processing. The firmware observation circuit is realized as a hardware monitoring block integrated with processing circuitry that captures execution state indicators, memory access activity, and control flow transitions through hardware-level observation of instruction execution and bus activity. The telemetry preconditioning unit is implemented as a processing hardware module containing a timing reference generator in the form of an electronic clocking circuit that assigns unified time references and aligns incoming data streams, and further includes dedicated logic circuitry for correlating events and generating structured composite telemetry representations. The compression processing unit is implemented using a hardware processing core coupled with memory access controllers configured to perform data reduction operations, segment analysis, and encoding functions in a controlled and repeatable manner. The adaptive threshold control circuit is realized as a hardware-based control module containing storage access pathways and comparison logic that reads historical telemetry behavior from non-transitory memory and dynamically adjusts operational parameters. The telemetry validation unit is implemented as a separate hardware verification block including comparison circuitry and structural analysis logic configured to evaluate data organization and reconstructability. The transmission management unit is formed by communication interface hardware that includes channel monitoring circuitry, scheduling logic, and prioritization controllers to regulate outgoing telemetry flow. The non-transitory memory is implemented as a physical storage device integrated into the system to retain telemetry records, structural fingerprints, and buffered segments. Interconnection between these components is achieved through hardware data buses, control signal pathways, and synchronization lines that enable coordinated operation. Each of these elements exists as a tangible electronic structure configured to execute specific operational tasks, ensuring that telemetry capture, conditioning, compression, validation, and transmission are performed through physically realized circuitry rather than abstract functionality.

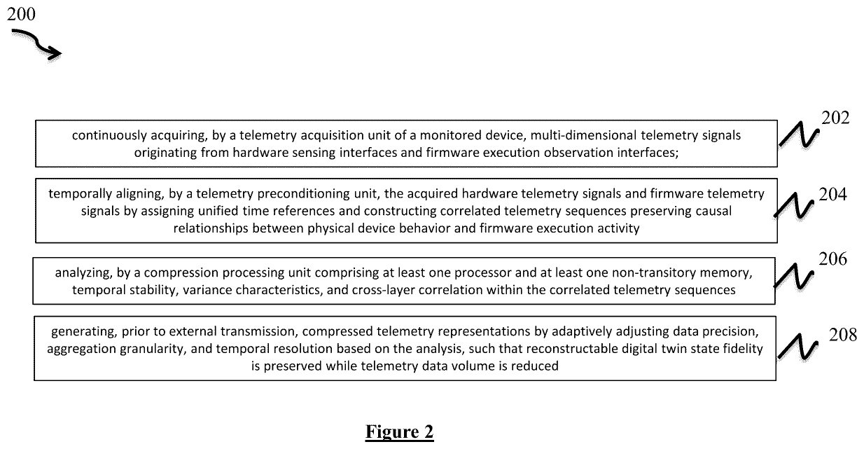

Referring to FIG. 2, a flow chart for a method for digital twin telemetry compression for on-device co-monitoring of hardware and firmware states, the method comprising the steps of is illustrated. The method 200 comprises:

At step 202, the method 200 includes continuously acquiring, by a telemetry acquisition unit of a monitored device, multi-dimensional telemetry signals originating from hardware sensing interfaces and firmware execution observation interfaces;

At step 204, the method 200 includes temporally aligning, by a telemetry preconditioning unit, the acquired hardware telemetry signals and firmware telemetry signals by assigning unified time references and constructing correlated telemetry sequences preserving causal relationships between physical device behavior and firmware execution activity;

At step 206, the method 200 includes analyzing, by a compression processing unit comprising at least one processor and at least one non-transitory memory, temporal stability, variance characteristics, and cross-layer correlation within the correlated telemetry sequences; and

At step 208, the method 200 includes generating, prior to external transmission, compressed telemetry representations by adaptively adjusting data precision, aggregation granularity, and temporal resolution based on the analysis, such that reconstructable digital twin state fidelity is preserved while telemetry data volume is reduced.

In an embodiment, further comprising receiving electrical, thermal, timing, and power-related telemetry signals from physical components of the monitored device and receiving firmware execution indicators including execution state transitions, memory access behavior, and control flow events, and integrating the received signals into a unified telemetry data structure prior to compression.

In an embodiment, temporally aligning the acquired telemetry signals comprises synchronizing hardware telemetry events and firmware execution events using a common timing reference generated within the monitored device to preserve event ordering and causality during subsequent compression.

In an embodiment, analyzing temporal stability comprises identifying telemetry segments exhibiting repetitive or low-variation behavior and selectively applying increased compression precision reduction to the identified telemetry segments relative to telemetry segments associated with detected state transitions.

In an embodiment, further comprising dynamically modifying compression parameters in real time by comparing current telemetry characteristics with historical telemetry behavior stored in the non-transitory memory and adjusting compression precision thresholds based on detected deviations.

In an embodiment, further comprising generating telemetry fingerprints representing structural characteristics of the compressed telemetry representations and storing the telemetry fingerprints locally within the monitored device for validation and reconstruction verification.

In an embodiment, further comprising validating integrity and reconstructability of the compressed telemetry representations by comparing the generated telemetry fingerprints with expected structural profiles prior to authorizing telemetry transmission.

In an embodiment, further comprising inhibiting transmission of compressed telemetry representations that fail integrity or reconstruct ability validation and reapplying compression using modified precision and aggregation parameters.

In an embodiment, further comprising regulating telemetry transmission scheduling by dynamically evaluating available communication bandwidth and prioritizing transmission of telemetry segments associated with detected abnormal operating conditions of the monitored device.

In an embodiment, further comprising adjusting compression processing behavior based on power availability of the monitored device by reducing processor utilization or modifying compression frequency during low-power operating states.

The present invention provides a detailed technique implementation for a digital twin telemetry compression system that operates directly on a monitored device to enable continuous co-monitoring of hardware and firmware states while reducing telemetry transmission overhead. The technique is executed by coordinated interaction of a telemetry acquisition unit, a telemetry preconditioning unit, a compression processing unit, a telemetry validation unit, and a transmission management unit, each functioning in a tightly coupled sequence to ensure that compressed telemetry remains reconstructable and semantically aligned with the physical device behavior.

At the initial stage of the technique, the telemetry acquisition unit continuously samples and captures raw telemetry signals generated within the monitored device. Hardware-originated telemetry includes physical measurements such as electrical voltage levels, current consumption, thermal readings, timing counters, and operational state indicators derived from sensors and embedded measurement circuits. In parallel, firmware-originated telemetry is collected from execution observation interfaces that expose firmware state transitions, instruction execution timing, memory access behavior, task scheduling events, and control flow changes. The technique ensures that telemetry acquisition occurs at a granularity sufficient to preserve causal relationships between hardware events and firmware execution behavior without imposing rigid sampling constraints.

Following acquisition, the telemetry preconditioning unit executes a temporal alignment technique that assigns unified internal time references to both hardware and firmware telemetry streams. This alignment process correlates events across layers by ordering telemetry samples according to a common timing baseline derived from the monitored device itself. The technique constructs correlated telemetry sequences in which hardware state changes are explicitly associated with contemporaneous firmware execution states, enabling downstream compression logic to recognize cross-layer dependencies rather than treating telemetry streams as independent data sources.

Once temporally aligned telemetry sequences are generated, the compression processing unit executes a multi-stage analysis technique. In a first analysis phase, the technique evaluates temporal stability by examining successive telemetry samples to identify segments exhibiting repetitive behavior, low variance, or steady-state conditions. Telemetry segments with minimal change over time are flagged as candidates for aggressive data reduction. In a second analysis phase, the technique evaluates variance characteristics across telemetry dimensions to identify signals that contribute limited incremental information. In a third analysis phase, cross-layer correlation analysis is performed to determine dependencies between hardware telemetry and firmware telemetry, allowing redundant representations to be consolidated while preserving causality.

Based on the results of the analysis phases, the compression processing unit dynamically determines compression parameters. The technique adaptively adjusts data precision by reducing numerical resolution for stable telemetry signals while maintaining higher precision for telemetry segments associated with state transitions, threshold crossings, or anomalous behavior. Temporal resolution is adjusted by selectively aggregating telemetry samples over time intervals that preserve behavioral trends without transmitting every individual sample. Aggregation granularity is determined based on operational context, such that critical operating modes invoke finer-grained telemetry representation than non-critical or idle modes.

The technique further incorporates historical telemetry behavior stored in non-transitory memory to refine compression decisions. By comparing current telemetry patterns with previously observed patterns and reconstruction outcomes, the compression processing unit modifies internal thresholds governing precision reduction and aggregation behavior. This adaptive feedback mechanism enables the technique to evolve over time, improving compression efficiency while maintaining reconstructability of digital twin states.

After generating compressed telemetry representations, the telemetry validation unit executes an integrity and reconstructability verification technique. This technique generates telemetry fingerprints that encode structural characteristics of the compressed telemetry, such as dimensional consistency, temporal ordering, and correlation preservation. The fingerprints are compared against expected structural profiles derived from the compression parameters and telemetry context. If validation confirms that the compressed telemetry can be accurately reconstructed, the telemetry is authorized for transmission. If validation fails, the technique triggers recompression with modified parameters to restore reconstructability.

The transmission management unit then executes a scheduling technique that determines when and how compressed telemetry is transmitted. This technique evaluates real-time communication bandwidth availability, device power state, and monitoring priority. Telemetry segments associated with detected abnormal operating conditions or significant state changes are prioritized for immediate transmission, while non-critical telemetry segments may be deferred or transmitted at reduced frequency. The technique ensures that compression and transmission decisions are coordinated to minimize latency for critical events while conserving bandwidth and energy.

Throughout operation, the technique incorporates energy-aware processing behavior. The compression processing unit adjusts processor utilization, memory access patterns, and compression frequency based on available power resources. During low-power states, the technique reduces computational intensity while maintaining essential telemetry fidelity, ensuring that monitoring continuity is preserved without excessive energy consumption.

The entire technique operates as a continuous closed-loop process within the monitored device. Telemetry acquisition, temporal alignment, analysis, adaptive compression, validation, and transmission are repeatedly executed in real time, enabling sustained synchronization between the physical device and its corresponding digital twin. By embedding this technique directly within the device architecture, the invention eliminates reliance on external gateway-based compression and enables fine-grained, context-aware telemetry optimization that preserves monitoring accuracy while significantly reducing transmission overhead.

The digital twin telemetry compression system is realized as a physical machine structure integrated within or coupled to a monitored device, such as an embedded controller, industrial machine, computing platform, or cyber-physical system. The structure comprises a telemetry intake assembly configured to receive raw telemetry signals generated by hardware sensing elements and firmware execution layers. These signals include, but are not limited to, electrical measurements, thermal readings, execution counters, memory access patterns, timing traces, and event notifications.

The telemetry intake assembly is operatively connected to a compression processing unit structurally implemented using embedded processing circuitry and memory arrays. This unit executes adaptive compression logic that evaluates telemetry dimensionality, temporal stability, variance profiles, and correlation patterns across hardware and firmware data streams. Based on this evaluation, the unit dynamically assigns compression precision levels, selectively aggregates telemetry dimensions, and encodes telemetry sequences into reduced representations that preserve operational significance.

The system further incorporates a bandwidth optimization structure that continuously monitors available transmission capacity, power state of the device, and urgency of telemetry delivery. This structure interacts with the compression processing unit to modulate compression aggressiveness in real time, ensuring that critical telemetry is transmitted with higher fidelity while non-critical or redundant data is compressed more aggressively or deferred.

A telemetry validation structure is physically embedded within the device architecture and configured to verify compressed telemetry integrity using fingerprinting, consistency checks, and reconstruction feasibility analysis. This validation structure ensures that compressed telemetry maintains sufficient information content to support accurate digital twin state reconstruction and anomaly detection.

The machine structure further includes a telemetry transmission interface that delivers compressed telemetry packets to an external digital twin environment, cloud system, or supervisory controller. The transmission interface operates in coordination with the compression and validation structures to ensure reliable and timely data delivery under varying network conditions.

In operation, the system continuously cycles through telemetry acquisition, adaptive compression, validation, and transmission, forming a closed-loop telemetry management process embedded directly within the monitored device. This structural integration enables the device to function as an intelligent telemetry source capable of self-optimizing data output based on operational context and monitoring requirements.

The invention may be embodied as a digital twin telemetry compression device comprising a physical housing containing an internal telemetry coupling bus interfaced with hardware sensors and firmware execution monitors. The housing supports a compression processing board incorporating processing circuits, memory units, and energy management components. The device further includes internal data pathways linking telemetry intake ports to compression logic and validation circuits, forming a structurally cohesive telemetry compression machine.

In an alternative embodiment, the system is integrated directly onto a device motherboard or embedded system substrate, wherein the telemetry compression circuitry is co-located with firmware execution environments. This structural arrangement minimizes telemetry latency and enables fine-grained cross-layer correlation between hardware and firmware telemetry prior to compression.

The machine structure is scalable and configurable to support varying telemetry densities, device classes, and monitoring criticalities, making it suitable for industrial automation equipment, IoT devices, medical systems, automotive electronics, and aerospace platforms.

The disclosed invention provides a structurally embedded telemetry compression mechanism that significantly reduces bandwidth consumption while preserving digital twin accuracy. By co-monitoring hardware and firmware telemetry within a unified compression framework, the system enhances diagnostic resolution and anomaly detection reliability. The adaptive compression logic enables energy-efficient operation and extends device lifetime in power-constrained environments. The machine-level integration ensures real-time responsiveness, scalability, and seamless interoperability with existing digital twin infrastructures.

The invention is industrially applicable to any system requiring continuous digital twin synchronization under bandwidth or power constraints. It is particularly suited for smart manufacturing systems, industrial control devices, edge computing platforms, embedded medical equipment, autonomous systems, and large-scale IoT deployments where efficient telemetry handling is critical for operational intelligence and system reliability.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

1. A digital twin telemetry compression system configured for on-device co-monitoring of hardware and firmware states, the system comprising:
a telemetry acquisition unit physically coupled to at least one hardware sensing interface and at least one firmware execution observation interface of a monitored device, the telemetry acquisition unit being configured to continuously collect multi-dimensional telemetry signals representing physical operating conditions and firmware execution behavior;
a telemetry preconditioning unit operatively connected to the telemetry acquisition unit and configured to normalize, timestamp, and structurally align the collected telemetry signals into correlated hardware-firmware telemetry sequences;
a compression processing unit operatively connected to the telemetry preconditioning unit and comprising at least one processor and at least one non-transitory memory, the compression processing unit being configured to analyze temporal stability, variance characteristics, and cross-layer correlation of the correlated telemetry sequences and to generate compressed telemetry representations by adaptively adjusting data precision, aggregation granularity, and temporal resolution;
a transmission management unit operatively connected to the compression processing unit and configured to regulate telemetry output based on available communication bandwidth, device power state, and monitoring priority; and
a telemetry output interface configured to transmit the compressed telemetry representations to an external digital twin system, wherein the compression processing unit performs telemetry reduction prior to transmission while preserving reconstructable digital twin state fidelity.

2. The system of claim 1, wherein the telemetry acquisition unit comprises a hardware signal coupling circuit configured to receive electrical, thermal, timing, and power-related signals from physical components of the monitored device, and a firmware observation circuit configured to receive execution state indicators, memory access patterns, and control flow events generated by firmware executing on the monitored device, and wherein the telemetry preconditioning unit is configured to temporally synchronize hardware telemetry signals and firmware telemetry signals by assigning unified time references and to generate a composite telemetry structure that preserves causal relationships between physical events and firmware execution transitions.

3. The system of claim 1, wherein the compression processing unit is configured to identify telemetry segments exhibiting low temporal entropy and to apply higher compression precision reduction to such segments while maintaining higher data precision for telemetry segments associated with detected state transitions or anomalous behavior, and wherein the compression processing unit further comprises an adaptive threshold control circuit configured to modify compression parameters in real time based on historical telemetry behavior stored in the non-transitory memory and current operating context of the monitored device.

4. The system of claim 1, wherein the compression processing unit is configured to generate telemetry fingerprints representing structural characteristics of compressed telemetry representations, the telemetry fingerprints being stored locally for subsequent validation and reconstruction verification, and further comprising a telemetry validation unit operatively connected to the compression processing unit and configured to verify integrity and reconstructability of compressed telemetry representations by comparing generated telemetry fingerprints with expected structural profiles prior to transmission.

5. The system of claim 7, wherein the telemetry validation unit is configured to inhibit transmission of compressed telemetry representations that fail integrity or reconstructability verification and to request recompression with modified precision parameters, and wherein the transmission management unit is configured to dynamically schedule telemetry transmission frequency based on real-time bandwidth availability and to defer non-critical telemetry segments while prioritizing transmission of telemetry segments associated with detected abnormal operating conditions.

6. The system of claim 1, wherein the compression processing unit is configured to perform compression operations using energy-aware processing sequences that adjust processor utilization and memory access patterns based on current power availability of the monitored device.

7. The system of claim 2, wherein the telemetry acquisition unit is configured to continuously sample the electrical, thermal, timing, and power-related signals through the hardware signal coupling circuit using interrupt-driven acquisition pathways, and to capture the execution state indicators, memory access patterns, and control flow events through the firmware observation circuit using event-triggered monitoring hooks embedded within the firmware execution environment, and wherein the telemetry preconditioning unit is further configured to align the sampled hardware telemetry signals and the captured firmware telemetry signals by assigning unified time references through a common timing reference generator, to correlate temporally adjacent hardware and firmware events by constructing ordered event sequences, and to generate the composite telemetry structure by embedding synchronized event identifiers and temporal offset markers within the unified telemetry representation so as to preserve the causal ordering of physical state changes and firmware execution transitions.

8. The system of claim 2, wherein the telemetry preconditioning unit is configured to detect and correct timing inconsistencies between the hardware telemetry signals and the firmware telemetry signals by identifying temporal discontinuities and applying compensatory time offset adjustments, and further configured to segment the composite telemetry structure into causally coherent telemetry blocks by grouping synchronized physical and firmware events occurring within predefined temporal windows, the telemetry blocks being structured to retain inter-event dependencies and contextual relationships required for downstream compression and validation operations.

9. The system of claim 3, wherein the compression processing unit is configured to determine the telemetry segments exhibiting low temporal entropy by calculating variation metrics across consecutive telemetry samples within each telemetry segment, to dynamically assign compression precision levels based on the calculated variation metrics, and to selectively retain higher-resolution representations for telemetry segments associated with detected state transitions by identifying abrupt changes in signal amplitude, execution state variation, or control flow deviations within the composite telemetry structure, and wherein the adaptive threshold control circuit is configured to continuously monitor historical telemetry behavior stored in the non-transitory memory and to derive context-sensitive compression thresholds by correlating prior telemetry variation patterns with current operating context indicators, and further configured to modify compression parameters in real time by adjusting precision reduction levels, sampling retention intervals, and data encoding density based on detected changes in device workload intensity, operational stability, and power consumption characteristics.

10. The system of claim 4, wherein the compression processing unit is configured to generate the telemetry fingerprints by extracting structural attributes from the compressed telemetry representations including segment boundaries, temporal density distributions, data continuity signatures, and encoded event correlation markers, and to construct a structural fingerprint descriptor by combining the extracted structural attributes into a compact representation that uniquely characterizes the internal organization of the compressed telemetry representations, and wherein the telemetry validation unit is configured to verify integrity and reconstructability of the compressed telemetry representations by retrieving the telemetry fingerprints stored locally, comparing structural attributes of a newly generated compressed telemetry representation with corresponding attributes of the stored telemetry fingerprints, and identifying deviations indicative of data loss, corruption, or structural inconsistency prior to authorizing transmission of the compressed telemetry representations.

11. The system of claim 5, wherein the telemetry validation unit is further configured to request recompression with modified precision parameters by transmitting control instructions to the compression processing unit specifying adjusted compression precision levels and retention parameters when structural inconsistencies are detected, and wherein the compression processing unit is configured to recompress the affected telemetry segments by selectively restoring previously reduced precision levels and regenerating the telemetry fingerprints for subsequent validation, and wherein the transmission management unit is configured to dynamically schedule telemetry transmission frequency by continuously monitoring bandwidth utilization levels and communication channel availability, to classify telemetry segments as critical or non-critical based on the presence of abnormal operating conditions identified within the composite telemetry structure, and to assign higher transmission priority to telemetry segments containing synchronized physical and firmware events associated with anomalous operational behavior.

12. The system of claim 6, wherein the compression processing unit is configured to perform the energy-aware processing sequences by modulating processor activity cycles and memory access frequency in response to the current power availability of the monitored device, to temporarily defer non-essential compression operations during periods of reduced power availability, and to execute prioritized compression of telemetry segments associated with detected abnormal operating conditions while maintaining reduced processing load for routine telemetry segments, and wherein the compression processing unit is further configured to monitor instantaneous power consumption patterns of the monitored device and to adjust data handling operations by redistributing compression workloads across multiple processing intervals, selectively buffering telemetry segments in the non-transitory memory during low power conditions, and initiating deferred compression cycles upon detection of restored power availability so as to maintain continuity of telemetry processing without interrupting ongoing monitoring functions.

13. The system of claim 2, wherein the telemetry acquisition unit is further configured to establish event-linked sampling of the electrical, thermal, timing, and power-related signals by activating the hardware signal coupling circuit in response to detected changes in the execution state indicators captured by the firmware observation circuit, and wherein the telemetry preconditioning unit is configured to embed event association markers within the composite telemetry structure to explicitly link hardware-originated signal variations with corresponding firmware execution transitions occurring within a correlated temporal interval.

14. The system of claim 3, wherein the compression processing unit is further configured to perform context-adaptive segmentation of the composite telemetry structure by dividing the telemetry into dynamically determined segments based on detected signal stability, execution continuity, and temporal density of event occurrence, and to apply differentiated compression operations to each dynamically determined segment by selectively adjusting data precision retention, encoding density, and segment boundary preservation based on the operational context represented within each segment.

15. The system of claim 4, wherein the telemetry validation unit is configured to perform multi-stage reconstructability verification by simulating partial reconstruction of the compressed telemetry representations using locally stored telemetry fingerprints, identifying structural inconsistencies across reconstructed telemetry segments through comparison of temporal alignment markers and event continuity indicators, and generating validation status signals indicative of reconstructability readiness prior to enabling transmission control through the transmission management unit.

16. The system of claim 6, wherein the compression processing unit is further configured to coordinate the energy-aware processing sequences with telemetry acquisition timing by dynamically synchronizing compression execution intervals with periods of reduced telemetry acquisition activity, to temporarily store incoming telemetry segments in the non-transitory memory during active acquisition intervals, and to initiate deferred compression operations during acquisition idle intervals so as to maintain continuous telemetry capture while regulating processor utilization and memory access patterns in accordance with current power availability of the monitored device.
